(19) United States
(12) Patent Application Publication
(10) Pub. No.: US 2023/0142593 A1
(43) Pub. Date: May 11, 2023

(54) CONFERENCE SPEECH ENHANCEMENT METHOD, APPARATUS, AND SYSTEM

(71) Applicant: HUAWEI TECHNOLOGIES CO., LTD., Shenzhen (CN)

(72) Inventor: Zhihui LIU, Dongguan (CN)

(21) Appl. No.: 18/154,151

(22) Filed: Jan. 13, 2023

Related U.S. Application Data
(63) Continuation of application No. PCT/CN2021/103388, filed on Jun. 30, 2021.

(30) Foreign Application Priority Data
Jul. 16, 2020 (CN) 202010685503.2
Sep. 25, 2020 (CN) 202011024263.8

(51) Int. Cl. H04R 1/40; H04R 3/00

(52) U.S. Cl. CPC H04R 1/406; H04R 3/005

(57) ABSTRACT

An example conference speech enhancement method includes obtaining information about a sound pickup area and a location relationship between a first microphone array and a second microphone array. A relative location relationship can then be obtained between a sound source and each of the first microphone array and the second microphone array. Location information of the sound source can then be determined based on the location relationship and the relative location relationship. In response to determining that the sound source is located in the sound pickup area, enhancing a sound signal corresponding to the sound source.

### CROSS-REFERENCE TO RELATED APPLICATIONS

This application is a continuation of International Application No. PCT/CN2021/103388, filed on Jun. 30, 2021, which claims priority to Chinese Patent Application No. 202011024263.8, filed on Sep. 25, 2020, which claims priority to Chinese Patent Application No. 202010685503.2, filed on Jul. 16, 2020, all of which are hereby incorporated by reference in their entireties.

### TECHNICAL FIELD

This application relates to the field of speech enhancement technologies, and in particular, to a conference speech enhancement method, an apparatus, and a system.

### BACKGROUND

In a conference system, because a conference device is deployed in an open area or noise interference from an open area exists in a conference room in which a conference device is deployed, when a conferee does not speak, external interference noise is picked up by a microphone of a conference, is transmitted to a remote end, and is heard by another conferee, affecting conference experience. Therefore, suppressing interference noise outside a conference area, to enhance only a sound in the conference area is an important purpose of improving experience in the conference system, and is also an urgent problem to be resolved.

### SUMMARY

According to a conference speech enhancement method, an apparatus, and a system provided in this application, two microphone arrays are deployed, to enhance only a sound signal in a predetermined sound pickup area, and improve conference experience.

To achieve the foregoing objective, this application provides the following technical solutions:

According to a first aspect, this application provides a conference speech enhancement method.

Before the method is implemented, an administrator deploys two microphone arrays, namely, a first microphone array and a second microphone array, in a local conference area. Then, the administrator configures information about a sound pickup area and a location relationship between the deployed first microphone array and the deployed second microphone array based on the local conference area.

The conference speech enhancement method includes: obtaining the information about the sound pickup area and the location relationship between the first microphone array and the second microphone array that are configured by the administrator; obtaining a relative location relationship between a sound source and each of the first microphone array and the second microphone array; determining location information of the sound source based on the obtained location relationship between the first microphone array and the second microphone array and the obtained relative location relationship between the sound source and each of the first microphone array and the second microphone array; and when determining that the sound source is located in the sound pickup area, enhancing a sound signal corresponding to the sound source.

In the first aspect of this application, a location of the sound source is determined by using two microphone arrays, and a sound signal corresponding to a sound source determined to be located in a preset sound pickup area is enhanced, to enhance only the sound signal corresponding to the sound source in the preset sound pickup area, and improve conference experience.

With reference to the first aspect, in a possible implementation, the conference speech enhancement method further includes: when determining that the sound source is located outside the sound pickup area, suppressing the sound signal corresponding to the sound source. In this way, an interference sound signal from an outside of the preset sound pickup area can be suppressed, and conference experience can be further improved.

With reference to the first aspect, in a possible implementation, the first microphone array and the second microphone array are located in a specified sound pickup area, and are located on a central axis of the sound pickup area. Optionally, a midpoint of a connecting line between the first microphone array and the second microphone array coincides with a center point of the sound pickup area. In this way, the sound signal in the sound pickup area can be collected more evenly.

The method for obtaining the information about the sound pickup area and the location relationship between the first microphone array and the second microphone array may be: locally receiving the information about the sound pickup area and the location relationship between the first microphone array and the second microphone array that are configured by the administrator, for example, locally receiving, by using conference software, the information configured by the administrator; or receiving, over a network, the information about the sound pickup area and the location relationship between the first microphone array and the second microphone array that are sent by another device.

With reference to the first aspect, in a possible implementation, the information about the sound pickup area may be a coordinate range of a point on a boundary of the sound pickup area relative to a reference point. The location information of the sound source may be coordinate information of the sound source relative to the reference point. The reference point may be the midpoint of the connecting line between the first microphone array and the second microphone array. Therefore, a method for determining that the sound source is located in the sound pickup area may be: determining, based on the location information of the sound source and the information about the sound pickup area, that a location of the sound source is within a location range indicated by the information about the sound pickup area.

Optionally, the sound pickup area may be the same as the local conference area, to help pick up only a sound signal in the local conference area. Therefore, a shape of the sound pickup area may be a rectangle, a circle, or the like the same as the local conference area.

With reference to the first aspect, in a possible implementation, the location relationship between the first microphone array and the second microphone array includes: a distance between the first microphone array and the second microphone array; a first angle of a sound pickup reference direction of the first microphone array relative to a connecting line; and a second angle of a sound pickup reference direction of the second microphone array relative to the connecting line. The connecting line is a connecting line between the first microphone array and the second microphone array.

With reference to the first aspect, in a possible implementation, the process of obtaining a relative location relationship between a sound source and each of the first microphone array and the second microphone array includes: obtaining a third angle of a connecting line between the sound source and the first microphone array relative to the sound pickup reference direction of the first microphone array; and obtaining a fourth angle of a connecting line between the sound source and the second microphone array relative to the sound pickup reference direction of the second microphone array.

Further, the method for obtaining a third angle of a connecting line between the sound source and the first microphone array relative to the sound pickup reference direction of the first microphone array may be: calculating the third angle based on a time point at which each microphone in the first microphone array collects a sound signal and a topology of the first microphone array; or receiving, over the network, the third angle sent by the another device.

With reference to the first aspect, in a possible implementation, the method for determining location information of the sound source based on the location relationship between the first microphone array and the second microphone array and the relative location relationship between the sound source and each of the first microphone array and the second microphone array may be: determining a first included angle between the connecting line between the sound source and the first microphone array and the connecting line between the first microphone array and the second microphone array based on the first angle and the third angle; similarly, determining a second included angle between the connecting line between the sound source and the second microphone array and the connecting line between the first microphone array and the second microphone array based on the second angle and the fourth angle; and calculating the location information of the sound source based on the first included angle, the second included angle, and the distance between the first microphone array and the second microphone array.

Optionally, the conference speech enhancement method further includes: further mixing, switching, and encoding the enhanced sound signal, and sending the mixed, switched, and encoded sound signal to a remote conference terminal, or sending the mixed, switched, and encoded sound signal to a conference terminal in the local conference area, so that the conference terminal sends the encoded sound signal to a remote conference terminal. In this way, the remote conference terminal can receive the enhanced sound signal in the preset sound pickup area.

Optionally, the conference speech enhancement method further includes: sending the enhanced sound signal to a conference terminal in the local conference area, so that the conference terminal further processes, for example, mixes, switches, and encodes the enhanced sound signal, and sends the processed sound signal to a remote conference terminal. In this way, the remote conference terminal can receive the enhanced sound signal in the preset sound pickup area.

Optionally, the conference speech enhancement method further includes: mixing and switching the enhanced sound signal, and sending the processed sound signal to a conference terminal in the local conference area, so that the conference terminal further encodes the processed sound signal and sends the encoded sound signal to a remote conference terminal. In this way, the remote conference terminal can receive the enhanced sound signal in the preset sound pickup area.

According to a second aspect, this application provides a conference system. The conference system may be configured to perform any method provided in the first aspect. The conference system may include a conference apparatus, a first microphone array, and a second microphone array.

The first microphone array and the second microphone array are configured to collect a speech signal.

The conference apparatus is configured to perform any conference speech enhancement method provided in the first aspect. For explanations of related content and descriptions of beneficial effects of a technical solution in any possible implementation of the conference apparatus, refer to the technical solution provided in any one of the first aspect or the corresponding possible designs of the first aspect. Details are not described herein again.

According to a third aspect, this application provides a conference apparatus. The conference apparatus may be configured to perform any method provided in the first aspect. In this case, the conference apparatus may be specifically a processor or a device including the processor.

In a possible implementation, division into functional modules of the apparatus may be performed according to any method provided in the first aspect. In this implementation, the conference apparatus includes an obtaining unit and a processing unit.

The obtaining unit is configured to: obtain information about a sound pickup area and a location relationship between a first microphone array and a second microphone array; and obtain a relative location relationship between a sound source and each of the first microphone array and the second microphone array.

The processing unit is configured to: determine location information of the sound source based on the location relationship between the first microphone array and the second microphone array and the relative location relationship between the sound source and each of the first microphone array and the second microphone array; and when determining that the sound source is located in the sound pickup area, enhance a sound signal corresponding to the sound source.

The processing unit is further configured to: when determining that the sound source is located outside the sound pickup area, suppress the sound signal corresponding to the sound source.

When obtaining the information about the sound pickup area and the location relationship between the first microphone array and the second microphone array, the obtaining unit is specifically configured to: locally receive the information about the sound pickup area and the location relationship between the first microphone array and the second microphone array that are configured by an administrator; or receive, over a network, the information about the sound pickup area and the location relationship between the first microphone array and the second microphone array that are sent by another device.

The location relationship between the first microphone array and the second microphone array includes: a distance between the first microphone array and the second microphone array; a first angle of a sound pickup reference direction of the first microphone array relative to a connecting line between the first microphone array and the second microphone array; and a second angle of a sound pickup reference direction of the second microphone array relative to the connecting line between the first microphone array and the second microphone array.

The relative location relationship between the sound source and each of the first microphone array and the second microphone array includes: a third angle of a connecting line between the sound source and the first microphone array relative to the sound pickup reference direction of the first microphone array; and a fourth angle of a connecting line between the sound source and the second microphone array relative to the sound pickup reference direction of the second microphone array.

Further, when obtaining the third angle of the connecting line between the sound source and the first microphone array relative to the sound pickup reference direction of the first microphone array, the obtaining unit is specifically configured to: calculate the third angle based on a time point at which different microphones in the first microphone array collect a sound signal and a topology of the first microphone array; or receive, over the network, the third angle sent by the another device.

When determining the location information of the sound source based on the location relationship between the first microphone array and the second microphone array and the relative location relationship between the sound source and each of the first microphone array and the second microphone array, the processing unit is specifically configured to: calculate a first included angle between the connecting line between the sound source and the first microphone array and the connecting line between the first microphone array and the second microphone array based on the first angle and the third angle; similarly, calculate a second included angle between the connecting line between the sound source and the second microphone array and the connecting line between the first microphone array and the second microphone array based on the second angle and the fourth angle; and calculate the location information of the sound source based on the first included angle, the second included angle, and the distance between the first microphone array and the second microphone array.

When determining that the sound source is located in the sound pickup area, the processing unit is specifically configured to determine, based on the location information of the sound source and the information about the sound pickup area, that a location of the sound source is within a location range indicated by the information about the sound pickup area.

Optionally, the conference apparatus further includes a sending unit.

Optionally, the processing unit is further configured to mix, switch, and encode the enhanced sound signal. In this case, the sending unit is configured to send the encoded sound signal to a conference terminal in a local conference area, so that the conference terminal sends the received sound signal to a remote conference terminal; or the sending unit is configured to directly send the encoded sound signal to a remote conference terminal.

Optionally, the sending unit is configured to send, to a conference terminal in a local conference area, the sound signal enhanced by the processing unit, so that the conference terminal further mixes, switches, and encodes the sound signal and sends the mixed, switched, and encoded sound signal to a remote conference terminal.

Optionally, the processing unit is further configured to mix and switch the enhanced sound signal. In this case, the sending unit is configured to send, to a conference terminal in a local conference area, the sound signal processed by the processing unit, so that the conference terminal further encodes the sound signal and sends the encoded sound signal to a remote conference terminal.

In another possible design, the conference apparatus includes a memory and one or more processors. The memory and the processor are coupled. The memory is configured to store computer program code. The computer program code includes computer instructions, and when the computer instructions are executed by the conference apparatus, the conference apparatus is enabled to perform the conference speech enhancement method according to any one of the first aspect and the possible design manners of the first aspect.

According to a fourth aspect, this application provides a computer-readable storage medium. The computer-readable storage medium includes computer instructions. When the computer instructions run on a conference system, the conference system is enabled to implement the conference speech enhancement method according to any possible design manner provided in the first aspect.

According to a fifth aspect, this application provides a computer program product. When the computer program product runs on a conference system, the conference system is enabled to implement the conference speech enhancement method according to any possible design manner provided in the first aspect.

For specific descriptions of the second aspect to the fifth aspect and the implementations of the second aspect to the fifth aspect in this application, refer to detailed descriptions of the first aspect and the implementations of the first aspect. In addition, for beneficial effects of the second aspect to the fifth aspect and the implementations of the second aspect to the fifth aspect, refer to analysis of beneficial effects in the first aspect and the implementations of the first aspect. Details are not described herein again.

In this application, a name of the conference system does not constitute a limitation on a device or a functional module. In an actual implementation, the device or the functional module may be represented by using another name. Each device or functional module falls within the scope defined by the claims and their equivalent technologies in this application, provided that a function of the device or functional module is similar to that described in this application.

### BRIEF DESCRIPTION OF DRAWINGS

To describe the technical solutions in embodiments of this application more clearly, the following briefly describes the accompanying drawings for describing embodiments of this application. It is clear that the accompanying drawings in the following description show merely some embodiments of this application, and a person of ordinary skill in the art may still derive other drawings from these accompanying drawings without creative efforts.

FIG. 1 is a schematic diagram of a system architecture according to an embodiment of this application;

FIG. 2 is a schematic diagram of a first conference area and a deployment of a microphone array according to an embodiment of this application;

FIG. 3A and FIG. 3B are a schematic diagram of a location relationship between a sound source and a microphone array according to an embodiment of this application;

FIG. 4A, FIG. 4B, and FIG. 4C are a schematic diagram of a principle of calculating a location of a sound source according to an embodiment of this application;

FIG. 5 is a schematic flowchart of a first conference speech enhancement method according to an embodiment of this application;

FIG. 6 is a schematic diagram of a second conference area and a deployment of a microphone array according to an embodiment of this application;

FIG. 7A and FIG. 7B are a schematic flowchart of a second conference speech enhancement method according to an embodiment of this application;

FIG. 8 is a schematic diagram of an entity structure of a conference apparatus according to an embodiment of this application; and

FIG. 9 is a schematic diagram of a logical structure of a conference apparatus according to an embodiment of this application.

### DESCRIPTION OF EMBODIMENTS

The following describes in detail implementation principles and specific implementations of the technical solutions in this application, and corresponding beneficial effects that can be achieved thereby with reference to the accompanying drawings.

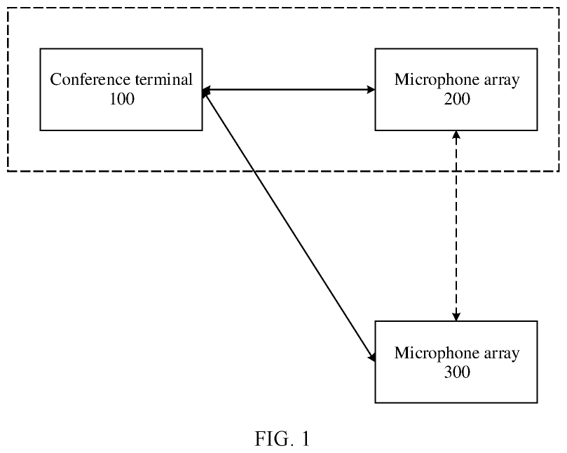

FIG. 1 is a schematic diagram of an architecture of a conference system to which an embodiment of this application is applied. The conference system includes a conference terminal 100, a microphone array 200, and a microphone array 300.

The microphone array 200 and the conference terminal 100 may be physically integrated together and are used as one device. In this case, the microphone array 200 may be a built-in microphone array of the conference terminal 100. The microphone array 300 is connected to the conference terminal 100.

The microphone array 200 and the conference terminal 100 may alternatively be two physically separate devices. In this case, the microphone array 200 is connected to the conference terminal 100. The microphone array 300 may be connected to the microphone array 200, or connected to the conference terminal 100, or connected to both the conference terminal 100 and the microphone array 200.

In the schematic diagram of the system architecture shown in FIG. 1, a quantity of conference terminals and microphone arrays and a form do not constitute a limitation on this embodiment.

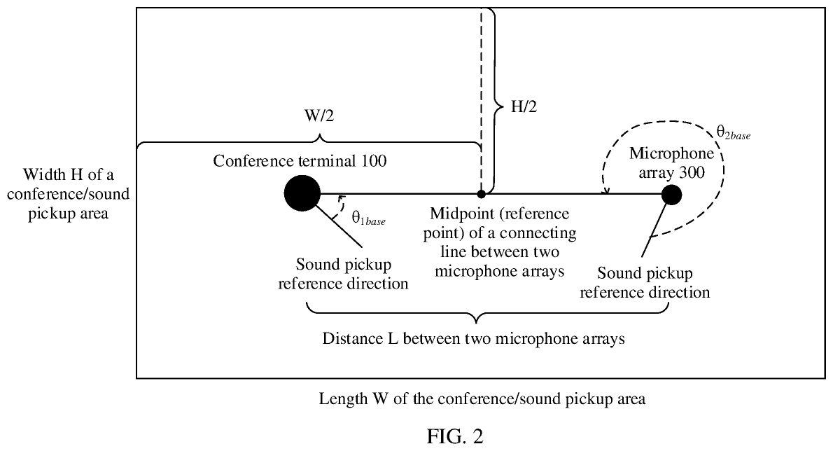

The microphone array is also referred to as a microphone array. Usually, a plurality of microphones are arranged based on a specific spatial structure, and sound signals in different directions can be collected and processed based on a spatial characteristic of an array structure. Usually, a direction of a sound source may be determined based on a sound signal collected by the microphone array. For example, an azimuth of the sound source relative to the microphone array is calculated based on a time point at which the sound signal arrives at different microphones in the microphone array and a topology of the microphone array. In this embodiment of this application, the azimuth is an included angle of a sound pickup reference direction of the microphone array relative to a connecting line between the sound source and the microphone array on a first plane. The first plane is a plane (a plane shown in FIG. 2) including the microphone array and the following sound pickup area. For ease of description, in this embodiment of this application, the azimuth is defined as a counterclockwise included angle from the sound pickup reference direction of the microphone array to the connecting line between the sound source and the microphone array on the first plane. It can be understood that the azimuth may also be a clockwise included angle from the sound pickup reference direction of the microphone array to the connecting line between the sound source and the microphone array on the first plane. The sound pickup reference direction of the microphone array is a positioning reference direction of the microphone array specified in the system.

A positioning angle range supported by the used microphone array is not limited in this embodiment. For example, a microphone array that supports positioning in a range from 0 degrees to 180 degrees may be used, or a microphone array that supports positioning in a range from 0 degrees to 360 degrees may be used.

The conference system in this embodiment of this application is deployed in a specific conference area, namely, a local conference area, and a sound pickup area is set based on the local conference area. In a conference process, a sound located in the sound pickup area is enhanced, and then the enhanced sound is sent to a remote conference terminal; and a sound located outside the sound pickup area is suppressed, and the suppressed sound is not sent to the remote conference terminal. The remote conference terminal is a conference terminal located in a remote conference area, and the remote conference area is another conference area that participates in a same conference as the local conference area.

In addition, the local conference area may be some space of an open area to which a conference terminal in the local conference area radiates. This is not limited in this application.

The following describes three possible implementations of the conference system provided in this embodiment of this application by using an example in which the conference terminal 100 and the microphone array 200 are integrated into one device.

In a first possible implementation, the microphone array 200 is built in the conference terminal 100, and the microphone array 300 is connected to the conference terminal 100. In this implementation, the conference terminal 100 may complete determining of a location of the sound source, determining of whether the sound source is in the sound pickup area, and processing, for example, enhancing or suppressing, of the sound signal. A specific implementation is as follows:

The conference terminal 100 is configured with conference control software. The conference terminal 100 is configured to receive configuration information of a conference administrator by using the conference control software. The configuration information includes information about the sound pickup area and a location relationship between the microphone array 200 and the microphone array 300. The conference terminal 100 is configured to determine a location relationship between the sound source and the microphone array 200 based on a sound signal collected by the built-in microphone array 200. The conference terminal 100 is configured to: receive a sound signal that is collected by the microphone array 300 and that is sent by the microphone array 300, and determine a location relationship between the sound source and the microphone array 300 based on the sound signal. The conference terminal 100 is configured to: determine location information of the sound source based on the location relationship between the microphone array 200 and the microphone array 300 and the location relationship between the sound source and each of the microphone array 200 and the microphone array 300, and determine, based on the location information, whether the sound source is located in the sound pickup area. If it is determined that the sound source is located in the sound pickup area, a sound signal corresponding to the sound source is enhanced. Further, the enhanced sound signal is mixed, switched, and encoded, and then sent to the remote conference terminal. If it is determined that the sound source is not located in the sound pickup area, the sound signal corresponding to the sound source is suppressed, and is not sent to the remote conference terminal.

The microphone array 300 is configured to: collect the sound signal, and send the collected sound signal to the conference terminal 100 in real time.

In a second possible implementation, the conference terminal 100 does not have a capability of determining a location of the sound source, determining whether the sound source is in the sound pickup area, and processing the sound signal in the first implementation. The microphone array 300 may not only collect the sound signal, but also have computing and storage capabilities. In this implementation, the microphone array 300 may complete determining of the location of the sound source, determining of whether the sound source is in the sound pickup area, and processing of the sound signal. Specifically, the conference terminal 100 is configured to: send configuration information, for example, information about the sound pickup area and a location relationship between the microphone array 200 and the microphone array 300, to the microphone array 300, and send, to the microphone array 300, a sound signal collected by the built-in microphone array 200. The microphone array 300 is configured to: receive the configuration information and the sound signal collected by the microphone array 200 that are sent by the conference terminal 100, and determine a location relationship between the sound source and the microphone array 200 based on the sound signal. The microphone array 300 is further configured to: collect a sound signal, and determine a location relationship between the sound source and the microphone array 300 based on the sound signal. The microphone array 300 is further configured to complete, in a processing manner similar to that of the conference terminal 100 in the first implementation, a task of determining the location of the sound source, determining whether the sound source is in the sound pickup area, and enhancing or suppressing the sound signal.

Further, the enhanced sound signal may be sent to the conference terminal 100. The conference terminal 100 is further configured to: mix, switch, and encode the received sound signal, and send the mixed, switched, and encoded sound signal to the remote conference terminal.

In a third possible implementation, determining of a location of the sound source, determining of whether the sound source is in the sound pickup area, and processing of the sound signal may alternatively be completed in both the conference terminal 100 and the microphone array 300. In this implementation, implementations of the conference terminal 100 and the microphone array 300 are respectively similar to the first implementation and the second implementation. In this implementation, a sound signal located in the sound pickup area is enhanced by each of the conference terminal 100 and the microphone array 300, and there is a better enhancement effect.

In an actual case, the microphone array 200 may also be a microphone array independent of the conference terminal 100. In this case, the microphone array 200 and the microphone array 300 each are an extended microphone array of the conference terminal 100. In this scenario, similar to the first possible implementation and the second possible implementation, the task of determining the location of the sound source, determining whether the sound source is in the sound pickup area, and processing the sound signal may be completed on the conference terminal 100, or may be completed on either of the microphone array 200 or the microphone array 300. Alternatively, similar to the third possible implementation, the task is completed on any two of the conference terminal 100, the microphone array 200, or the microphone array 300. However, it should be noted that if the microphone array 300 is only connected to the microphone array 200, the microphone array 200 may be used as a communication bridge between the microphone array 300 and the conference terminal 100. For example, the microphone array 300 may send, in real time to the conference terminal 100 by using the microphone array 200, the sound signal collected by the microphone array 300; or the conference terminal 100 sends the configuration information to the microphone array 300, or the like by using the microphone array 200.

It can be learned that, in the conference system provided in this embodiment of this application, in the conference process, the location of the sound source is determined by using two microphone arrays to jointly perform sound source positioning, to clearly determine whether the sound source is located in a specified sound pickup area. In addition, a sound signal corresponding to a sound source located in the specified sound pickup area is enhanced, and a sound signal corresponding to a sound source located outside the specified sound pickup area is suppressed. Therefore, the sound signal in the predetermined sound pickup area is enhanced, and the sound signal outside the predetermined sound pickup area is suppressed, to improve conference experience.

Further, in this embodiment of this application, the enhanced sound signal may be further mixed, switched, and encoded, and then sent to the remote conference terminal, but the suppressed sound signal is not sent to the remote conference terminal. In this way, the remote conference terminal can receive only the enhanced sound from the specified sound pickup area, but cannot receive the sound from an outside of the sound pickup area, to improve conference experience.

With reference to FIG. 2 to FIG. 5, the following describes in detail a first conference speech enhancement method provided in an embodiment of this application. This embodiment is applied to the first implementation in the system architecture. To be specific, a conference terminal 100 determines a location of a sound source, determines whether the sound source is in a sound pickup area, and enhances or suppresses a sound signal. In addition, a microphone array 200 is built in the conference terminal 100.

Before the method is specifically performed, an administrator deploys the conference terminal 100 and a microphone array 300 in a conference area. In this embodiment, an example in which the conference area is a rectangle, a length corresponding to the rectangle is W, and a width is H is used for description. Usually, to uniformly collect a sound signal in the conference area, the conference terminal 100 and the microphone array 300 may be deployed on a central axis of the rectangle corresponding to the conference area. In a preferred manner, during deployment, a center of a connecting line between the conference terminal 100 and the microphone array 300 may be maintained to coincide with a center of the conference area.

FIG. 2 is a schematic diagram of a conference area and a deployment of a microphone array according to an embodiment. In this figure, the conference terminal 100 and the microphone array 300 are deployed in the preferred manner. To be specific, the conference terminal 100 and the microphone array 300 are deployed on a central axis in a corresponding horizontal direction of the conference area, and the center of the connecting line between the conference terminal 100 and the microphone array 300 coincides with the center of the conference area.

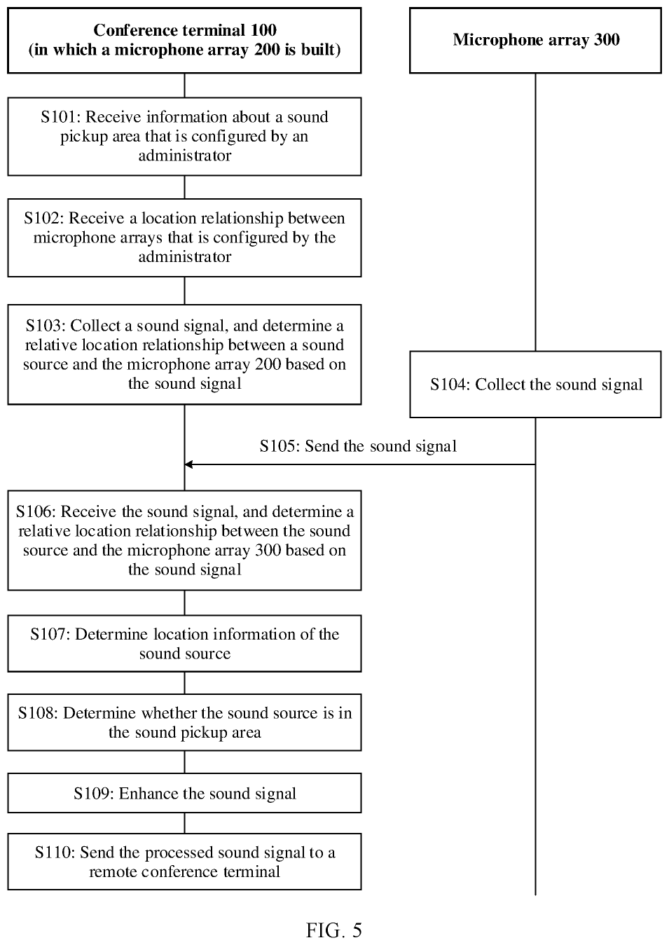

FIG. 5 is a schematic flowchart of a conference speech enhancement method according to an embodiment. The method includes but is not limited to the following steps.

Step S101: The conference terminal 100 receives information about a sound pickup area that is configured by the administrator.

Specifically, the conference administrator configures the sound pickup area by using conference control software on the conference terminal 100. The information about the sound pickup area is used to indicate a range in which a sound needs to be picked up. For example, the information about the sound pickup area may be a coordinate range of a point on a boundary of the sound pickup area relative to a reference point. The reference point is a midpoint of a connecting line between the microphone array 200 and the microphone array 300. Coordinates are coordinates in a coordinate system in which the reference point is used as an origin and a rightward direction of the connecting line between the microphone array 200 and the microphone array 300 is used as a horizontal axis.

In this embodiment, it is assumed that the sound pickup area set by the administrator is the same as the conference area, so that only a sound in the conference area is picked up. Therefore, referring to FIG. 2, a horizontal distance between a rightmost point of the sound pickup area and the reference point is W/2, and a vertical distance between an uppermost point of the sound pickup area and the reference point is H/2. Therefore, a horizontal coordinate range and a vertical coordinate range of the point on the boundary of the sound pickup area relative to the reference point are respectively [−W/2, W/2] and [−H/2, H/2]. Therefore, the information that is about the sound pickup area and that is received by the conference terminal may be [−W/2, W/2] and [−H/2, H/2].

Step S102: The conference terminal 100 receives a location relationship between microphone arrays that is configured by the administrator.

Specifically, after the conference terminal 100 and the microphone array 300 are deployed, a location relationship between the microphone array 200 and the microphone array 300 is determined. The conference administrator may configure the location relationship between microphone arrays by using the conference control software on the conference terminal 100. The location relationship between microphone arrays includes a distance between the microphone array 200 and the microphone array 300, an angle of a sound pickup reference direction of the microphone array 200 relative to the connecting line between the microphone array 200 and the microphone array 300, and an angle of a sound pickup reference direction of the microphone array 300 relative to the connecting line between the microphone array 200 and the microphone array 300.

The angle of the sound pickup reference direction of the microphone array 200 relative to the connecting line between the microphone array 200 and the microphone array 300 is an included angle between the sound pickup reference direction of the microphone array 200 and the connecting line between the microphone array 200 and the microphone array 300. For ease of description, in this embodiment of this application, the angle is defined as a counterclockwise included angle from the sound pickup reference direction of the microphone array 200 to the connecting line.

Similarly, the angle of the sound pickup reference direction of the microphone array 300 relative to the connecting line with the microphone array 200 and the microphone array 300 is a counterclockwise included angle from the sound pickup reference direction of the microphone array 300 to the connecting line.

It can be understood that the angle may alternatively be a clockwise included angle from the sound pickup reference direction of the microphone array 200 or the sound pickup reference direction of the microphone array 300 to the connecting line.

Refer to FIG. 2. In this embodiment, the distance between the microphone array 200 and the microphone array 300 is equal to a distance between the conference terminal 100 and the microphone array 300, namely, L. The angle of the sound pickup reference direction of the microphone array 200 relative to the connecting line between the microphone array 200 and the microphone array 300 is θ_{1base}. The angle of the sound pickup reference direction of the microphone array 300 relative to the connecting line between the microphone array 200 and the microphone array 300 is θ_{2base}. Therefore, information about the location relationship between microphone arrays that is received by the conference terminal includes L, θ_{1base}, and θ_{2base}.

It can be understood that, if the sound pickup reference direction of the microphone array 200 is adjusted to be the same as that of the connecting line, θ_{1base} is 0 degrees or 180 degrees. Similarly, θ_{2base} may also be 0 degrees or 180 degrees.

Step S103: The built-in microphone array 200 in the conference terminal 100 collects a sound signal, and the conference terminal 100 determines a relative location relationship between the sound source and the microphone array 200 based on the sound signal.

The relative location relationship between the sound source and the microphone array 200 may be an azimuth of the sound source relative to the microphone array 200.

Specifically, when the microphone array 200 collects the sound signal, the conference terminal 100 records information about a time point at which each microphone in the microphone array 200 collects the sound signal, and then, performs a sound source positioning calculation based on the information about the time point and a topology of the microphone array 200 (for example, a spatial arrangement structure of each microphone in the microphone array 200), to obtain an azimuth θ_{1loc} of the sound source relative to the microphone array 200.

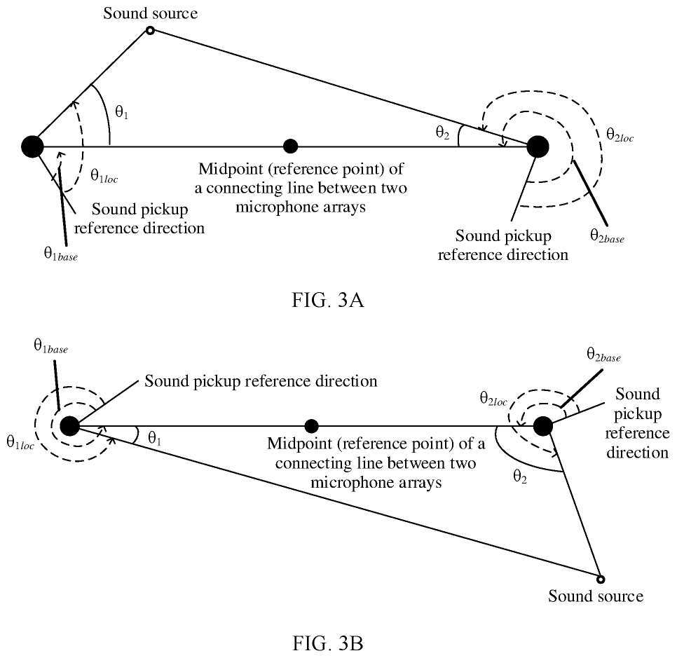

As explained above, in this embodiment of this application, the azimuth of the sound source relative to the microphone array 200 is the counterclockwise included angle from the sound pickup reference direction of the microphone array 200 to the connecting line between the sound source and the microphone array 200, for example, θ_{1loc} in FIG. 3A and FIG. 3B.

Steps S104 and S105: The microphone array 300 collects a sound signal, and sends the collected sound signal to the conference terminal 100 in real time.

After collecting a sound signal, each microphone in the microphone array 300 sends the collected sound signal to the conference terminal 100 in real time.

Step S106: The conference terminal 100 receives the sound signal sent by the microphone array 300, and determines a relative location relationship between the sound source and the microphone array 300 based on the sound signal.

The relative location relationship between the sound source and the microphone array 300 may be an azimuth of the sound source relative to the microphone array 300.

Specifically, the conference terminal 100 receives, in real time, the sound signal sent by each microphone in the microphone array 300, and records information about a time point at which the sound signal of each microphone is received. Similar to step S103, the conference terminal 100 performs sound source positioning based on the information about the time point and a topology of the microphone array 300, to obtain the azimuth θ_{2loc} of the sound source relative to the microphone array 300. A meaning of the azimuth is similar to that of the azimuth of the sound source relative to the microphone array 200. For the meaning, refer to θ_{2loc} shown in FIG. 3A and FIG. 3B. Details are not described herein again.

Step S107: The conference terminal 100 determines location information of the sound source.

Specifically, the conference terminal 100 determines the location information of the sound source based on the information about the location relationship between microphone arrays that is configured by the administrator, for example, L, θ_{1base}, and θ_{2base} and the relative location relationships θ_{1loc} and θ_{2loc} between the sound source and each of the microphone array 200 and the microphone array 300.

The location information of the sound source is coordinates of the sound source relative to the reference point, and the reference point is the midpoint of the connecting line between the microphone array 200 and the microphone array 300. Coordinates are coordinates in the coordinate system in which the reference point is used as the origin and the rightward direction of the connecting line between the microphone array 200 and the microphone array 300 is used as the horizontal axis.

A manner of calculating the location information of the sound source is as follows: Locations of the sound source, the microphone array 200, and the microphone array 300 are used as vertexes to form a triangle, and then, the coordinates of the sound source relative to the reference point are calculated based on the distance L between the microphone array 200 and the microphone array 300 (namely, a length of one side of the triangle), an included angle between the connecting line between the sound source and the microphone array 200 and the connecting line between the microphone array 200 and the microphone array 300 (namely, an angle corresponding to the microphone array 200 that is used as a vertex in the triangle), and an included angle between the connecting line between the sound source and the microphone array 300 and the connecting line between the microphone array 200 and the microphone array 300 (namely, an angle corresponding to the microphone array 300 that is used as a vertex in the triangle).

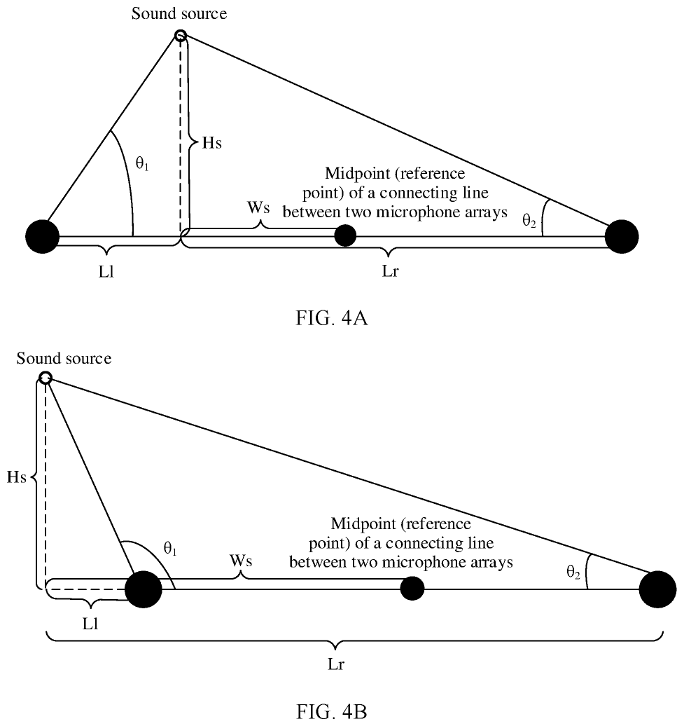

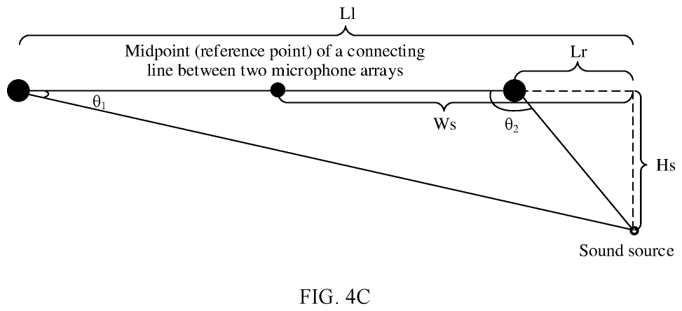

Refer to FIG. 3A, FIG. 3B, and FIG. 4A to FIG. 4C, a specific process of the manner of calculating the location information of the sound source may include the following three steps.

(1) Calculate an angle θ₁ corresponding to the microphone array 200 that is used as a vertex and an angle θ₂ corresponding to the microphone array 300 that is used as a vertex in the triangle in which the sound source, the microphone array 200, and the microphone array 300 are vertexes.

Herein, θ₁ is the included angle between the connecting line between the sound source and the microphone array 200 and the connecting line between the microphone array 200 and the microphone array 300, and the included angle θ₁ may be calculated based on θ_{1base} (namely, a relative angle between the sound pickup reference direction of the microphone array 200 and the connecting line between the microphone array 200 and the microphone array 300) in the location relationship between microphone arrays and the azimuth θ_{1loc} of the sound source relative to the microphone array 200.

Similarly, θ₂ may be calculated based on θ_{2base} (namely, a relative angle between the sound pickup reference direction of the microphone array 300 and the connecting line between the microphone array 200 and the microphone array 300) in the location relationship between microphone arrays and the azimuth θ_{2loc} of the sound source relative to the microphone array 300.

When the sound source is located in different directions of a microphone array, θ₁ and θ₂ may be obtained in different calculation manners. The following further explains specific calculation manners of θ₁ and θ₂ with reference to FIG. 3A and FIG. 3B.

Refer to FIG. 3A. θ₁=θ_{1loc}−θ_{1base}, and θ₂=θ_{2base}−θ_{2loc}.

Refer to FIG. 3B. θ₁=θ_{1base}−θ_{1loc}, and θ₂=360−(θ_{2base}−θ_{2loc}).

In FIG. 3B, because a degree difference between θ_{2base} and θ_{2loc} has exceeded 180 degrees, and θ_{2base}−θ_{2loc} is actually an angle obtained by subtracting θ₂ from an angle range around the microphone array 300, a value of θ₂ needs to be obtained by subtracting θ_{2base}−θ_{2loc} from 360.

It can be understood that, based on the specific calculation principle, θ₁ may be calculated in the following unified manner: θ₁=|θ_{1loc}−θ_{1base}|. If θ₁ calculated in this manner meets a condition θ₁>180, θ₁=360−|θ_{1loc}−θ_{1base}|.

Similarly, θ₂ may be obtained in the following unified manner: θ₂=|η_{2loc}−θ_{2base}|. If θ₂ calculated in this manner meets a condition θ₂>180, θ₂=360−|θ_{2loc}−θ_{2base}|.

(2) Calculate a horizontal distance Ws and a vertical distance Hs between the sound source and the reference point based on θ₁, θ₂, and the distance L between the microphone array 200 and the microphone array 300.

Specifically, it is assumed that a length of a vertical line from the sound source to the connecting line between the microphone array 200 and the microphone array 300 is Hs, a horizontal distance between the sound source and the microphone array 200 (the left microphone array in this embodiment) is L1, and a horizontal distance between the sound source and the microphone array 300 (the right microphone array in this embodiment) is Lr. The horizontal distance Ws and the vertical distance Hs between the sound source and the reference point may be calculated based on a rule of a trigonometric function.

The foregoing specific calculation may be performed in three cases based on values of θ₁ and θ₂. For ease of understanding, the following specifically explains the three cases with reference to FIG. 4A to FIG. 4C.

FIG. 4A shows a case in which θ₁ and θ₂ are right angles or acute angles. In other words, when a condition 0<θ₁≤90 and 0<θ₂≤90 is met, the following equation may be obtained based on the trigonometric function:

L1+Lr=L (1)

Tan(θ₁)=Hs/L1 (2)

Tan(θ₂)=Hs/Lr (3)

The following equations may be obtained based on equations (1), (2), and (3):

$$Hs = \frac{tan ( θ1 ) * tan ( θ2 ) * L}{tan ( θ 1 ) + tan ( θ 2 )}$$

$$L1 = \frac{tan ( θ 2 ) * L}{tan ( θ1 ) + tan ( θ2 )}$$

$$Lr = L - L 1$$

Further, Ws may be calculated based on L1 or Lr. For example,

$$Ws = \vert L 1 - \frac{L}{2} \vert , or$$

$$Ws = \vert L r - \frac{L}{2} \vert .$$

FIG. 4B shows a case in which θ₁ is an obtuse angle. In other words, when a condition 90<θ₁<180 is met, the following equations may be obtained based on the trigonometric function:

Lr−L1=L (4)

Tan(180−θ₁)=Hs/L1 (5)

Tan(θ₂)=Hs/Lr (6)

The following equations may be obtained based on equations (4), (5), and (6):

$$Hs = \frac{tan ( 180 - θ1 ) * tan ( θ 2 ) * L}{tan ( 1 \; 80 - θ1 ) + tan ( θ 2 )}$$

$$L 1 = \frac{tan ( θ 2 ) * L}{tan ( 1 \; 80 - θ1 ) + tan ( θ 2 )}$$

Further, a value of Ws may also be calculated based on L1 or Lr. For details, refer to descriptions in the example shown in FIG. 4A. Details are not described herein again.

FIG. 4C shows a case in which θ₂ is an obtuse angle. In other words, when a condition 90<θ₂<180 is met, similarly, the following equations may be obtained based on the trigonometric function:

L−Lr=L (7)

Tan(θ₁)=Hs/L1 (8)

Tan(180−θ₂)=Hs/Lr (9)

The following equations may be obtained based on equations (7), (8), and (9):

$$Hs = \frac{tan ( θ1 ) * tan ( 180 - θ 2 ) * L}{tan ( θ1 ) + tan ( 180 - θ 2 )}$$

$$L 1 = \frac{tan ( 180 - θ 2 ) * L}{tan ( θ1 ) + tan ( 180 - θ 2 )}$$

A value of the Ws may also be calculated based on L1 or Lr. Details are not described herein again.

(3) Determine whether Ws and Hs are positive or negative numbers.

Whether Ws is a positive or negative number may be determined based on values of L1 and Lr. Details are as follows:

If a condition L1<Lr is met, it indicates that the sound source is on the left of the reference point, and Ws is a negative number.

If a condition L1>Lr is met, it indicates that the sound source is on the right of the reference point, and Ws is a positive number.

If a condition L1=Lr is met, it indicates that the sound source is on a perpendicular bisector of the connecting line between the two microphone arrays, and Ws is 0.

Whether Hs is a positive or negative number may be determined based on values of θ_{1base} and θ_{1loc}.

When θ_{1base} meets a condition 0<θ_{1base}≤180, for example, in the example shown in FIG. 3A, Hs is a positive or negative number based on different ranges of θ_{1loc}. Specifically, if θ_{1loc} meets a condition θ_{1base}<θ_{1loc}<θ_{1base}+180, the sound source is located above the midpoint of the connecting line between the two microphone arrays, and a sign of Hs is a positive sign. If θ_{1loc} meets a condition θ_{1loc}>θ_{1base}+180 or θ_{1loc}<θ_{1base}, the sound source is located below the midpoint of the connecting line between the two microphone arrays, and a sign of Hs is a negative sign.

Based on the similar method, whether Hs is a positive or negative number may be learned of when θ_{1base} meets a condition θ_{1base}>180. Details are not described herein again.

It can be understood that, in any condition, when θ_{1loc} meets a condition θ_{1loc}=θ_{1base}+180 or θ_{1loc}=θ_{1base}, it indicates that the sound source is on a straight line on which the connecting line between the two microphone arrays is located, and Hs is 0. In this case, θ₁ and θ₂ meet a condition θ₁=θ₁=0.

Optionally, a sign of Hs may alternatively be determined based on values of θ_{2base} and θ_{21oc} in the similar manner. Details are not described herein again.

In examples shown in FIG. 4A and FIG. 4B, it can be learned, in the calculation method, that Ws is a negative number and Hs is a positive number. Therefore, in the two examples, the coordinates of the sound source relative to the reference point are (−Ws, Hs). In other words, the location information of the sound source is (−Ws, Hs).

Similarly, in the example shown in FIG. 4C, it can be learned that Ws is a positive number and Hs is a negative number. Therefore, the coordinates of the sound source relative to the reference point are (Ws, −Hs). In other words, the location information of the sound source is (Ws, −Hs).

Step S108: The conference terminal 100 determines whether the sound source is in the sound pickup area.

Specifically, the method in which the conference terminal 100 determines whether the sound source is in the sound pickup area includes: determining, based on the determined location information of the sound source and the information that is about the sound pickup area and that is configured by the administrator, whether the sound source is within a range indicated by the information about the sound pickup area.

In this embodiment, the range indicated by the information about the sound pickup area is a rectangle whose coordinate ranges are [−W/2, W/2] and [−H/2, H/2]. In the examples shown in FIG. 4A and FIG. 4B, the location information of the sound source is (−Ws, Hs). Therefore, if −Ws is within a range indicated by [−W/2, W/2] and Hs is within a range indicated by [−H/2, H/2], in other words, when −Ws meets a condition −W/2≤−Ws≤W/2 and Hs meets a condition −H/2≤Hs≤H/2, the sound source is in the sound pickup area. Alternatively, if −Ws is not within the range indicated by [−W/2, W/2] and Hs is not within the range indicated by [−H/2, H/2], the sound source is not in the sound pickup area. Similarly, in the example shown in FIG. 4C, the location information of the sound source is (Ws, −Hs). If Ws is within the range indicated by [−W/2, W/2] and −Hs is within the range indicated by [−H/2, H/2], in other words, when Ws meets a condition −W/2≤Ws≤W/2 and −Hs meets a condition −H/2≤−Hs≤H/2, the sound source is in the sound pickup area. Alternatively, if Ws is not within the range indicated by [−W/2, W/2] and −Hs is not within the range indicated by [−H/2, H/2], the sound source is not in the sound pickup area.

If it is determined that the sound source is in the sound pickup area, step S109 is performed. Alternatively, if it is determined that the sound source is not in the sound pickup area, the sound signal corresponding to the sound source is suppressed, for example, is attenuated.

Step S109: The conference terminal 100 enhances the sound signal.

Specifically, the conference terminal 100 enhances the sound signal, for example, performs filtering and echo cancellation on the sound signal.

Optionally, the conference terminal 100 may further mix and switch the enhanced sound signal, to obtain a sound signal with a better effect. The conference terminal 100 may further encode the processed sound signal, to facilitate transmission on a network.

In the process, the conference terminal 100 may further perform other processing on the sound signal. This is not limited in this application.

Step S110: The conference terminal 100 sends the processed sound signal to a remote conference terminal.

Optionally, the conference terminal 100 sends the processed, for example, enhanced sound signal to the remote conference terminal. In this way, the remote conference terminal can receive the enhanced sound signal in a local conference area.

It should be noted that, in steps S104 and S105, the microphone array 300 directly sends the collected sound signal to the conference terminal 100, and the conference terminal 100 calculates the relative location relationship between the sound source and the microphone array 300 (namely, the azimuth θ_{2loc} of the sound source relative to the microphone array 300). In an actual application, another possible implementation is as follows: After the microphone array 300 collects the sound signal, the microphone array 300 calculates θ_{2loc}, and then directly sends θ_{2loc} to the conference terminal 100. In this implementation, the microphone array 300 may not send, to the conference terminal 100, the sound signal collected by the microphone array 300. Correspondingly, in step S106, the conference terminal 100 may directly receive θ_{2loc} without performing a calculation process of θ_{2loc}.

In addition, it should be further noted that, in a conference process, a user usually intermittently or continuously speaks in the conference area, and in this embodiment, the microphone array 200 and the microphone array 300 continuously collect a sound signal, and the conference terminal 100 performs the processes such as determining and processing on the collected sound signal in real time. Therefore, step S103 to S110 are usually performed for a plurality of times.

As described above, in step S108, if the conference terminal 100 determines that the sound source is not in the sound pickup area, the conference terminal 100 suppresses the signal corresponding to the sound source and does not send the signal to the remote conference terminal. In this embodiment, a sound signal in a preset sound pickup area can be enhanced, and an interference signal outside the preset sound pickup area can be suppressed. Further, the remote conference terminal may receive only an enhanced sound signal from the local conference area, and does not receive a sound signal from an interference sound source outside the local conference area, to improve conference experience.

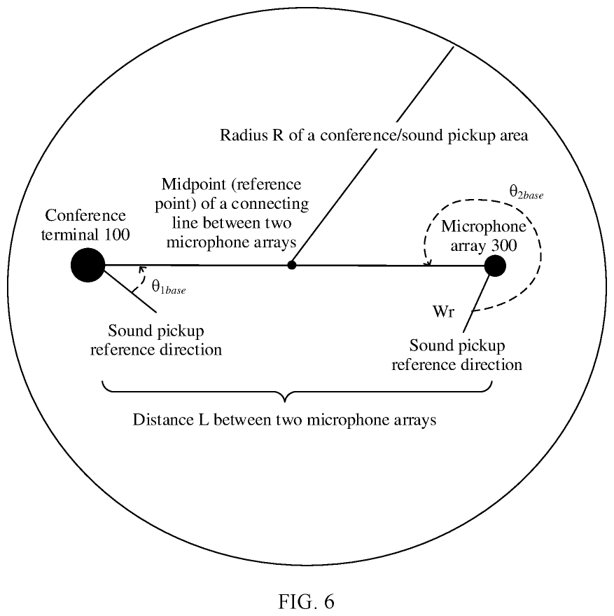

In this embodiment, it is assumed that the conference area and the sound pickup area are rectangles. In an actual case, the conference area may alternatively be of another shape, typically, for example, a circle. The following provides explanations with reference to FIG. 6 by using an example in which the conference area is a circle.

FIG. 6 is a schematic diagram of a second conference area and a deployment of a microphone array according to an embodiment of this application. In this example, it is assumed that the conference area is a circle with a radius of R. Similarly, for a scenario in which the conference area is a circle, to evenly pick up a sound signal of the conference area, a microphone array 200 and a microphone array 300 are usually deployed on a central axis of the circle, and a midpoint of a connecting line between the two microphone arrays coincides with a center of the circle. In this embodiment, it is assumed that an administrator deploys a conference terminal 100 and the microphone array 300 in the preferred manner. It can be understood that, because the two microphone arrays are to be located in the conference area, a distance L between the two microphone arrays is less than a diameter 2*R of the circle.

For such a conference area and deployment scenario, in step S101, it is assumed that a sound pickup area configured by the administrator is also a circle the same as the conference area. Then, a horizontal coordinate range of a point on a boundary of the sound pickup area relative to a reference point is [−R, R], and a vertical coordinate range of the point on the boundary of the sound pickup area relative to the reference point varies with a horizontal location of the point. For example, if a horizontal coordinate of the point relative to the reference point is X, the vertical coordinate range corresponding to the point is [−\sqrt{R²−31 X²}, \sqrt{R²−X²}].

Similarly, in step S108, if the conference terminal 100 determines that a location of a sound source is within ranges [−R, R] and [−\sqrt{R²−X²}, \sqrt{R²−X²}] indicated by the sound pickup area, the sound source is located in the sound pickup area.

For example, in FIG. 4A and FIG. 4B, location information of the sound source is (−Ws, Hs). If −Ws is within a range indicated by [−R, R] and Hs is within a range indicated by [−\sqrt{R²−Ws²}, \sqrt{R²−Ws²}], in other words, when −Ws meets a condition −R≤−Ws≤R and

Hs meets a condition −\sqrt{R²−Ws²}≤Hs≤\sqrt{R²−Ws²}, the sound source is in the sound pickup area.

Other steps are correspondingly the same as those in an implementation method described in the case in which the conference area is a rectangle. Therefore, details are not described again.

In addition, it can be understood that the conference area and the corresponding sound pickup area may be in any other shape different from the rectangle and the circle. Whether the sound source is in the sound pickup area can be determined provided that the information about the configured sound pickup area includes coordinate information of the point on the boundary of the sound pickup area relative to the reference point.

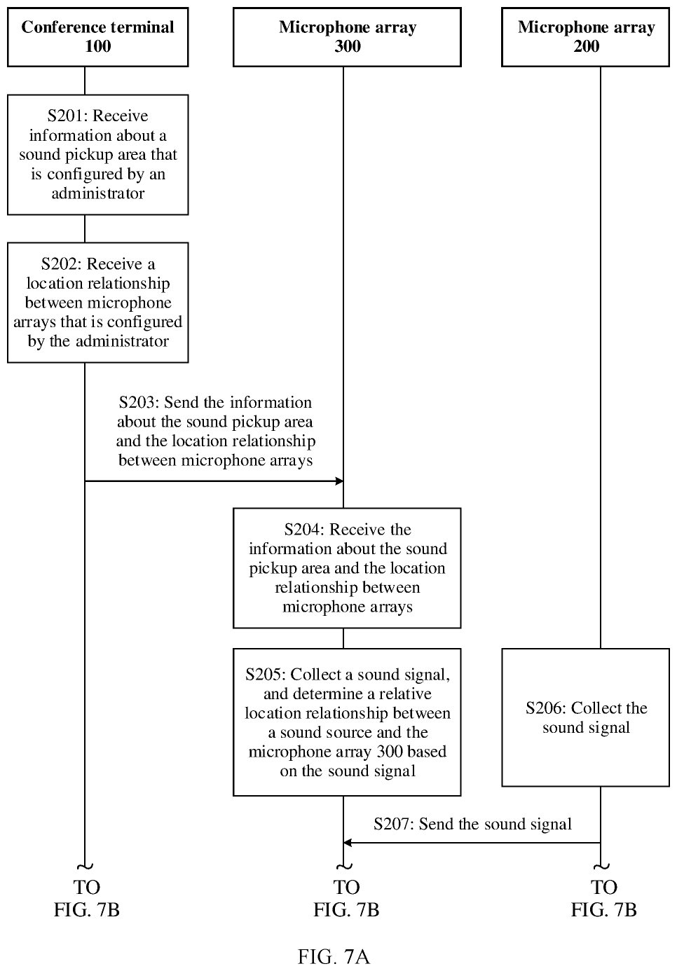

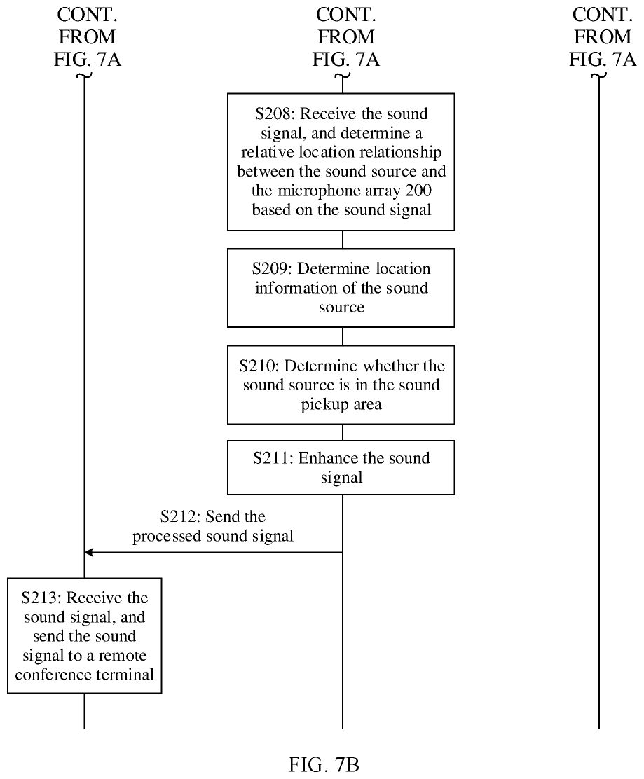

The following describes a second conference speech enhancement method according to an embodiment of this application with reference to FIG. 7A and FIG. 7B. In this embodiment, a microphone array 300 performs processing such as determining a location of a sound source, determining whether the sound source is in a sound pickup area, and enhancing or suppressing a sound signal. In addition, a microphone array 200 and the microphone array 300 each are a device independent of a conference terminal 100, and a connection manner between the three devices is: The microphone array 300 and the conference terminal 100 are connected, and the microphone array 200 and the microphone array 300 are connected.

In this embodiment, it is also assumed that a conference area is a rectangle whose length is W and width is H, and deployment manners of the microphone array 200 and the microphone array 300 are respectively the same as deployment manners of the conference terminal 100 (in which the microphone array 200 is built) and the microphone array 300 in the first implementation. It should be understood that in this embodiment of this application, a deployment location relationship between the microphone array 200 and the microphone array 300 is focused. In this embodiment, both the microphone array 200 and the microphone array 300 are independent of the conference terminal 100. Therefore, in this embodiment, the conference terminal 100 only needs to be connected to the microphone array 200, and a specific deployment location of the conference terminal 100 is not important.

FIG. 7A and FIG. 7B are a schematic flowchart of a second conference speech enhancement method according to an embodiment. The method includes but is not limited to the following steps.

For steps S201 and S202, refer to steps S101 and S102. Therefore, details are not described again.

Steps S203 and S204: The conference terminal 100 sends the information about the sound pickup area and the location relationship between microphone arrays to the microphone array 300. The microphone array 300 correspondingly receives the information about the sound pickup area and the location relationship between microphone arrays.

Specifically, the conference terminal 100 sends, to the microphone array 300, a sound pickup area [−W/2, W/2] and [−H/2, H/2] configured by an administrator and the location relationship L, θ_{1base}, and θ_{2base} between microphone arrays is configured by the administrator. The microphone array 300 correspondingly receives the information.

Steps S205 to S210 are respectively similar to steps S103 to S108. However, the microphone array 300 performs these steps instead of the conference terminal 100. Therefore, details are not described again.

Steps S211 and S212: The microphone array 300 enhances a sound signal, and sends the processed sound signal to the conference terminal 100.

The microphone array 300 may directly send the enhanced sound signal to the conference terminal 100; or may mix and switch the enhanced sound signal and then send the mixed and switched sound signal to the conference terminal 100; or may further perform encoding based on this, and then send the encoded sound signal to the conference terminal 100.

Step S213: The conference terminal 100 receives the sound signal sent by the microphone array 300, and sends the sound signal to a remote conference terminal.

Optionally, corresponding to step S211, before sending the received sound signal to the remote conference terminal, the conference terminal 100 may need to process, for example, mix, switch, or encode the received sound signal. For example, if the received sound signal is only enhanced, the conference terminal 100 needs to mix, switch, and encode the sound signal.

Finally, the conference terminal 100 sends the enhanced, mixed, switched, and encoded sound signal to the remote conference terminal.

In this way, the remote conference terminal can receive only the enhanced sound signal in a local conference area, but cannot receive an interference sound signal outside the local conference area. Therefore, conference experience can be improved. In the second speech enhancement method provided in this embodiment of this application, the microphone array 300 completes determining of the location of the sound source, determining of whether the sound source is in the sound pickup area, and processing of the sound signal, to achieve a same effect as the first method in embodiments of this application. In addition, more flexible implementations can be provided.

In addition, like descriptions of the conference system provided in embodiments of this application, determining of the location of the sound source, determining of whether the sound source is in the sound pickup area, and processing of the sound signal may be further completed in the microphone array 200, or may be simultaneously completed in any two device in the conference terminal 100, the microphone array 200, or the microphone array 300, to achieve a better sound pickup effect. Details are not described one by one herein again.

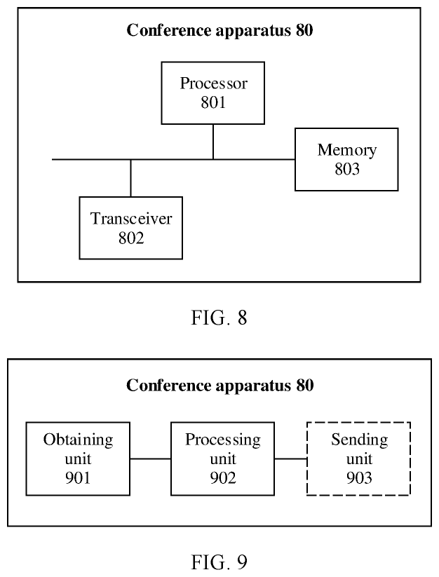

FIG. 8 is a schematic diagram of an entity structure of a conference apparatus 80 according to an embodiment of this application. The conference apparatus 80 may be configured to perform the conference speech enhancement method. With reference to the descriptions of the conference system and the conference speech enhancement method provided in embodiments of this application, the conference apparatus 80 may be the conference terminal 100 in the method shown in FIG. 5 or the microphone array 300 in the method shown in FIG. 7A and FIG. 7B, or may be another dedicated conference device with computing and storage capabilities. In addition, in an actual application, the conference apparatus 80 may be another general-purpose computing device, for example, a computer, a notebook computer, a tablet, or a smartphone. When the conference speech enhancement method provided in embodiments of this application is applied, the conference apparatus 80 may be directly or indirectly connected to both of two microphone arrays, or may be integrated with one microphone array and connected to another microphone array.

Because the conference apparatus 80 may execute the conference speech enhancement method, and a speech enhancement process is described in detail in the method embodiments, the following briefly describes only a structure and a function of the conference apparatus 80. For specific content, refer to content of the embodiments of the conference speech enhancement method.

As shown in FIG. 8, the conference apparatus 80 includes a processor 801, a transceiver 802, and a memory 803.

The processor 801 may be a controller, a central processing unit (CPU), a general purpose processor, a DSP, an ASIC, an FPGA, another programmable logic device, a transistor logic device, a hardware component, or any combination thereof. The processor may implement or execute various example logical blocks, modules, and circuits described with reference to content disclosed in embodiments of the present invention. Alternatively, the processor 801 may be a combination of processors implementing a computing function, for example, a combination of one or more microprocessors, or a combination of the DSP and a microprocessor.

The transceiver 802 may be a communications module or a transceiver circuit, and is configured to communicate with another device or a communications network.

The memory 803 may be a read-only memory (ROM) or another type of static storage device that can store static information and instructions, or a random access memory (RAM) or another type of dynamic storage device that can store information and instructions, or may be an electrically erasable programmable read-only memory (EEPROM), a compact disc read-only memory (CD-ROM) or another optical disk storage, an optical disc storage (including a compact disc, a laser disc, an optical disc, a digital versatile disc, a Blu-ray disc, or the like), a disk storage medium or another magnetic storage device, or any other medium that can be used to carry or store expected program code in a form of instructions or a data structure and that can be accessed by a computer. However, the memory 803 is not limited thereto. The memory 803 may be independent of the processor 801, or may be connected to the processor 801 by using a communications bus, or may be further integrated with the processor 801.

The memory 803 is configured to store data, instructions, or program code. When the processor 801 invokes and executes the instructions or the program code stored in the memory 803, the conference speech enhancement method provided in embodiments of this application can be implemented.

It should be noted that the schematic diagram of the structure shown in the foregoing figures does not constitute a limitation on embodiments of the present invention. In an actual application, the conference apparatus 80 may further include another component.

In addition, in embodiments of this application, the conference apparatus 80 may be divided into functional modules based on the foregoing method examples. For example, each functional module may be obtained through division for a corresponding function, or two or more functions may be integrated into one processing module. The integrated module may be implemented in a form of hardware, or may be implemented in a form of a software functional module. It should be noted that, in embodiments of this application, division into the modules is an example and is merely logical function division, and there may be another division manner in an actual implementation.

FIG. 9 is a schematic diagram of a logical structure of a conference apparatus 80 according to an embodiment of this application. The conference apparatus 80 may include an obtaining unit 901 and a processing unit 902.

The obtaining unit 901 is configured to: obtain information about a sound pickup area and a location relationship between a first microphone array and a second microphone array; and obtain a relative location relationship between a sound source and each of the first microphone array and the second microphone array.

The processing unit 902 is configured to determine location information of the sound source based on the location relationship between the first microphone array and the second microphone array and the relative location relationship between the sound source and each of the first microphone array and the second microphone array. The processing unit 902 is further configured to: when determining that the sound source is located in the sound pickup area, enhance the sound signal corresponding to the sound source.

The processing unit 902 is further configured to: when determining that the sound source is not located in the sound pickup area, suppress the sound signal corresponding to the sound source.

The location relationship between the first microphone array and the second microphone array includes: a distance between the first microphone array and the second microphone array; a first angle of a sound pickup reference direction of the first microphone array relative to a connecting line between the first microphone array and the second microphone array; and a second angle of a sound pickup reference direction of the second microphone array relative to the connecting line between the first microphone array and the second microphone array.

The relative location relationship between the sound source and each of the first microphone array and the second microphone array includes: a third angle of a connecting line between the sound source and the first microphone array relative to the sound pickup reference direction of the first microphone array; and a fourth angle of a connecting line between the sound source and the second microphone array relative to the sound pickup reference direction of the second microphone array.

In a possible implementation, when obtaining the information about the sound pickup area and the location relationship between the first microphone array and the second microphone array, the obtaining unit 901 is specifically configured to locally receive the information about the sound pickup area and the location relationship between the first microphone array and the second microphone array that are configured by an administrator. In this case, the conference apparatus 80 may be the conference terminal 100 in the example shown in FIG. 5. When obtaining the third angle of the connecting line between the sound source and the first microphone array relative to the sound pickup reference direction of the first microphone array, the obtaining unit 901 is specifically configured to calculate the third angle based on a time point at which different microphones in the first microphone array collect a sound signal and a topology of the first microphone array. In this implementation, with reference to FIG. 8, a function of the obtaining unit 901 may be completed by the processor 801.

In another possible implementation, when obtaining the information about the sound pickup area and the location relationship between the first microphone array and the second microphone array, the obtaining unit 901 is specifically configured to receive the information about the sound pickup area and the location relationship between the first microphone array and the second microphone array over a network. In this case, the conference apparatus 80 may be the microphone array 300 in the example shown in FIG. 7A and FIG. 7B. When obtaining the third angle of the connecting line between the sound source and the first microphone array relative to the sound pickup reference direction of the first microphone array, the obtaining unit 901 is specifically configured to receive, over the network, the third angle sent by another device, for example, the first microphone array. In this implementation, with reference to FIG. 8, a function of the obtaining unit 901 may be completed by the transceiver 802.

When determining the location information of the sound source based on the location relationship between the first microphone array and the second microphone array and the relative location relationship between the sound source and each of the first microphone array and the second microphone array, the processing unit 902 is specifically configured to: calculate a first included angle between the connecting line between the sound source and the first microphone array and the connecting line between the first microphone array and the second microphone array based on the first angle and the third angle; similarly, calculate a second included angle between the connecting line between the sound source and the second microphone array and the connecting line between the first microphone array and the second microphone array; and calculate the location information of the sound source based on the first included angle, the second included angle, and the distance between the first microphone array and the second microphone array.

When determining that the sound source is located in the sound pickup area, the processing unit 902 is specifically configured to: determine, based on the location information of the sound source and the information about the sound pickup area, that a location of the sound source is within a location range indicated by the information about the sound pickup area. Optionally, the conference apparatus 80 further includes a sending unit 903.

The sending unit 903 is configured to send the sound signal enhanced by the processing unit 902 to a conference terminal in a local conference area. After receiving the sound signal sent by the sending unit 903, the conference terminal mixes, switches, and encodes the enhanced sound signal, and then, sends the mixed, switched, and encoded sound signal to the remote conference terminal.

Optionally, the processing unit 902 is further configured to process, for example, mix, switch, and encode the enhanced sound signal. In this case, the sending unit 903 is configured to send the encoded sound signal to the conference terminal in the local conference area. After receiving the sound signal sent by the sending unit 903, the conference terminal sends the sound signal to the remote conference terminal. Alternatively, the sending unit 903 may be configured to directly send the encoded sound signal to the remote conference terminal.

With reference to FIG. 8, a function of the processing unit 902 may be completed by the processor 801, and a function of the sending unit 903 may be completed by the transceiver 802.

With reference to FIG. 5, the obtaining unit 901 may be configured to perform steps S101 to S103 and S106. The processing unit 902 may be configured to perform steps S107 to S109. The sending unit 903 may be configured to perform step S110.

With reference to FIG. 7A and FIG. 7B, the obtaining unit 901 may be configured to perform steps S204, S205, and S208. The processing unit 902 may be configured to perform steps S209 to S211. The sending unit 903 may be configured to perform step S212.

For specific descriptions of the optional manners, refer to the method embodiments. Details are not described herein again. In addition, for explanations of any provided conference apparatus and descriptions of beneficial effects, refer to the corresponding method embodiments. Details are not described herein again.

Another embodiment of this application further provides a computer-readable storage medium. The computer-readable storage medium stores instructions. When the instructions run on a conference system or a conference apparatus, the conference system or the conference apparatus performs steps performed by the conference system or the conference apparatus in the method procedure shown in the method embodiments.

All or some of the foregoing embodiments may be implemented by using software, hardware, firmware, or any combination thereof. When a software program is used to implement the foregoing embodiments, all or some of the foregoing embodiments may be implemented in a form of a computer program product. The computer program product includes one or more computer instructions. When the computer instructions are loaded and executed on the computer, all or some of the procedure or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

The foregoing descriptions are merely specific implementations of this application. A variation or replacement figured out by a person skilled in the art according to specific implementations provided in this application shall fall within the protection scope of this application.

1. A conference speech enhancement method, comprising:
obtaining information about a sound pickup area and a location relationship between a first microphone array and a second microphone array;
obtaining a relative location relationship between a sound source and each of the first microphone array and the second microphone array;
determining location information of the sound source based on the location relationship and the relative location relationship; and
in response to determining that the sound source is located in the sound pickup area, enhancing a sound signal corresponding to the sound source.

2. The method according to claim 1, wherein the determining that the sound source is located in the sound pickup area comprises:
determining, based on the location information of the sound source and the information about the sound pickup area, that a location of the sound source is within a location range indicated by the information about the sound pickup area.

3. The method according to claim 2, wherein the information about the sound pickup area comprises:
a coordinate range of a point on a boundary of the sound pickup area relative to a reference point, wherein the reference point is a midpoint of a connecting line between the first microphone array and the second microphone array.

4. The method according to claim 2, wherein the location information of the sound source comprises:
coordinate information of the sound source relative to a reference point, wherein the reference point is a midpoint of a connecting line between the first microphone array and the second microphone array.

5. The method according to claim 1, wherein the location relationship comprises:
a distance between the first microphone array and the second microphone array;
a first angle of a sound pickup reference direction of the first microphone array relative to a first connecting line between the first microphone array and the second microphone array; and
a second angle of a sound pickup reference direction of the second microphone array relative to the first connecting line.

6. The method according to claim 5, wherein the relative location relationship comprises:
a third angle of a second connecting line between the sound source and the first microphone array relative to the sound pickup reference direction of the first microphone array; and
a fourth angle of a third connecting line between the sound source and the second microphone array relative to the sound pickup reference direction of the second microphone array.

7. The method according to claim 6, wherein the determining location information of the sound source based on the location relationship and the relative location relationship comprises:
determining a first included angle between the second connecting line and the first connecting line based on the first angle and the third angle;
determining a second included angle between the third connecting line and the first connecting line based on the second angle and the fourth angle; and
calculating the location information of the sound source based on the first included angle, the second included angle, and the distance between the first microphone array and the second microphone array.

8. The method according to claim 1, wherein the first microphone array and the second microphone array are located in the sound pickup area, and are located on a central axis of the sound pickup area.

9. The method according to claim 1, wherein the obtaining information about a sound pickup area and a location relationship between a first microphone array and a second microphone array comprises:
locally receiving the information about the sound pickup area and the location relationship that are configured by an administrator; or receiving the information about the sound pickup area and the location relationship over a network.

10. The method according to claim 8, wherein a midpoint of a connecting line between the first microphone array and the second microphone array coincides with a center point of the sound pickup area.

11. A conference system, wherein the conference system comprises a conference apparatus, a first microphone array, and a second microphone array, wherein:
the first microphone array and the second microphone array are configured to collect sound signals; and
the conference apparatus is configured to:
obtain information about a sound pickup area, a location relationship between the first microphone array and the second microphone array, and a relative location relationship between a sound source and each of the first microphone array and the second microphone array;
determine location information of the sound source based on the location relationship and the relative location relationship; and
in response to determining that the sound source is located in the sound pickup area, enhance a sound signal corresponding to the sound source.

12. The conference system according to claim 11, wherein in response to determining that the sound source is located in the sound pickup area, the conference apparatus is configured to:
determine, based on the location information of the sound source and the information about the sound pickup area, that a location of the sound source is within a location range indicated by the information about the sound pickup area.

13. The conference system according to claim 12, wherein the information about the sound pickup area comprises:
a coordinate range of a point on a boundary of the sound pickup area relative to a reference point, wherein the reference point is a midpoint of a connecting line between the first microphone array and the second microphone array.

14. The conference system according to claim 12, wherein the location information of the sound source comprises:
coordinate information of the sound source relative to a reference point, wherein the reference point is a midpoint of a connecting line between the first microphone array and the second microphone array.

15. The conference system according to claim 11, wherein the location relationship comprises:
a distance between the first microphone array and the second microphone array;
a first angle of a sound pickup reference direction of the first microphone array relative to a first connecting line between the first microphone array and the second microphone array; and
a second angle of a sound pickup reference direction of the second microphone array relative to the first connecting line.

16. The conference system according to claim 11, wherein the first microphone array and the second microphone array are located in the sound pickup area, and are located on a central axis of the sound pickup area.

17. The conference system according to claim 11, wherein in response to obtaining the information about the sound pickup area and the location relationship, conference apparatus is configured to:
locally receive the information about the sound pickup area and the location relationship that are configured by an administrator; or receive the information about the sound pickup area and the location relationship over a network.

18. The conference system according to claim 16, wherein a midpoint of a connecting line between the first microphone array and the second microphone array coincides with a center point of the sound pickup area.

19. The conference system according to claim 11, wherein the conference apparatus is further configured to:
in response to determining that the sound source is located outside the sound pickup area, suppress the sound signal corresponding to the sound source.

20. A conference apparatus, comprising:
at least one processor; and
one or more memories coupled to the at least one processor and storing programming instructions for execution by the at least one processor to perform operations comprising:
obtaining information about a sound pickup area and a location relationship between a first microphone array and a second microphone array;
obtaining a relative location relationship between a sound source and each of the first microphone array and the second microphone array;
determining location information of the sound source based on the location relationship and the relative location relationship; and
in response to determining that the sound source is located in the sound pickup area, enhancing a sound signal corresponding to the sound source.
